(19) United States
(12) Patent Application Publication
(10) Pub. No.: US 2024/0110061 A1
(43) Pub. Date: Apr. 4, 2024

(54) ADHESION PROMOTER BASED ON A VAE-BASED REDISPERSIBLE POLYMER POWDER AND A WETTING AGENT, ASPHALT BINDER AND ASPHALT MIXTURE INCLUDING THE SAME

(71) Applicant: Wacker Chemie AG, Munich (DE)

(72) Inventors: Sung OH, Seongnam-si (KR); Yong-Hae CHOI, Seongnam-si (KR)

(73) Assignee: Wacker Chemie AG, Munich (DE)

(21) Appl. No.: 18/032,590

(22) PCT Filed: Nov. 4, 2020
(86) PCT No.: PCT/EP2020/080883

§ 371 Date: Apr. 19, 2023

(51) Int. Cl. C08L 95/00; C08K 13/02

(52) U.S. Cl. CPC C08L 95/005; C08K 13/02; C08K 5/17; C08L 2312/00; C08L 2555/80

(57) ABSTRACT

An asphalt binder includes an asphalt and an adhesion promoter composition. The adhesion promoter composition includes a vinyl acetate-ethylene (VAE)-based redispersible polymer and a wetting agent. The wetting agent includes at least one selected from the group consisting of: polyethylene glycol phenyl ether, polyethylene glycol higher alkyl, ether dialkyl sulfosuccinate, alkyl amine, alcohol amine, polyethyleneimine, and sorbitan aliphatic ethylene oxide adduct. Further, the wetting agent is included in an amount ranging from 0.5 to 45 percent by weight (wt %) with respect to the total weight of the adhesion promoter composition.

### TECHNICAL FIELD

Embodiments of the present invention relate to a vinyl acetate-ethylene (VAE)-based polymer adhesion promoter composition used for asphalt and concrete road pavement, capable of securing high adhesion between road pavement and aggregate, high cohesion, and excellent rheology as well, to an asphalt binder and an asphalt mixture including the vinyl acetate-ethylene (VAE)-based polymer adhesion promoter composition.

### DISCUSSION OF RELATED ART

Asphalt or bitumen (hereinafter, “asphalt”), is a term used to describe the residue left over from the petrochemical refining process. Asphalt is used in a variety of applications, for uses such as, but not limited to, paving, sealing, coating, roofing, waterproofing, draining, and as weather barriers.

Asphalt without modification typically tends to be stripped with aggregate by water, therefore lacking properties for use on its own in some of the applications mentioned above. A general strategy is to modify the asphalt with a variety of property enhancing polymers and/or additives.

Recently, a lot of studies are being conducted on asphalt modifiers in order to improve the performance of such asphalt. In order to improve adhesion (e.g., interfacial adhesion) between asphalt and aggregate, adhesion promoters in a type of, for example, a surfactant or a wax are widely used. Various physical properties are required to be used as an asphalt adhesion promoter. Among the required physical properties, the most critical one required may be adhesion between asphalt and aggregate, and cohesion of an asphalt binder itself. This is because surface coating and moisture resistance of the aggregate may be improved when the adhesion between asphalt and aggregate is excellent, and stripping resistance that may maintain coating against external force may be improved when cohesion of the asphalt binder itself is excellent.

Among adhesion promoters that are currently in wide use, surfactant-type adhesion promoters have advantages of excellent coating ability and rheology (e.g., fluidity) by improving adhesion. However, when the content of the surfactant-type adhesion promoter increases, the effect of improving physical properties of the asphalt binder is limited, causing more deformation against external stress that may be caused by the load arising from vehicle traffic, thus resulting in deterioration in road performance.

Accordingly, there is a need to develop a novel adhesion promoter capable of improving cohesion and rheology of the asphalt binder itself, while maintaining the adhesion between asphalt and aggregate.

### DETAILED DESCRIPTION OF THE INVENTION

### Technical Objectives

Aspects of embodiments of the present invention may be directed to an adhesion promoter composition that may provide excellent rheology along with compactness by mixedly using a vinyl acetate-ethylene (VAE)-based redispersible polymer, which is applied to various fields with excellent adhesion, eco-friendliness, a wetting agent and by adjusting their content in a predetermined ratio.

In addition, aspects of embodiments of the present invention may be also directed to an asphalt binder and an asphalt mixture including the above-described VAE-based adhesion promoter composition.

Other objects and advantages of the present invention may be more clearly described by the following detailed description and claims.

### Technical Solution to the Problem

According to an embodiment, an adhesion promoter composition includes: a vinyl acetate-ethylene (VAE)-based redispersible polymer; and a wetting agent, wherein the wetting agent is included in an amount ranging from 0.1 to 50 percent by weight (wt %) with respect to the total weight of the adhesion promoter composition.

In some embodiments, the VAE-based redispersible polymer may include: a VAE copolymer having a vinyl acetate (VA) content of more than 50 wt % with respect to the total weight of the VAE-based redispersible polymer; and a filler.

In some embodiments, the VAE copolymer may include VA in an amount more than 50 wt % and less than or substantially equal to 99 wt %; and ethylene in an amount more than or substantially equal to 1 wt % and less than 50 wt %.

In some embodiments, the VAE copolymer may have a glass transition temperature (Tg) ranging from −40° C. to 25° C.

In some embodiments, the filler may include an organic filler, an inorganic filler, or a mixture thereof.

In some embodiments, the filler may be included in an amount ranging from 0.1 to 30 wt % with respect to 100 wt % of the VAE-based redispersible polymer.

In some embodiments, the wetting agent may include at least one selected from the group consisting of: sodium polyacrylate, styrene maleic anhydride, saponified product of maleic anhydride copolymer, saponified product of olefin copolymer, sodium alkylnaphthalene sulfonic acid-formalin condensate, sodium ligninsulfonate, polyethylene glycol phenyl ether, polyethylene glycol higher alkyl, ether dialkyl sulfosuccinate, alkyl amine, alcohol amine, polyethyleneimine, and sorbitan aliphatic ethylene oxide adduct.

In some embodiments, the adhesion promoter composition may further include a crosslinking agent in an amount ranging from 0.1 to 15 wt % with respect to the total weight of the adhesion promoter composition.

In some embodiments, the crosslinking agent may include at least one selected from the group consisting of: an organic peroxide crosslinking agent, a silane crosslinking agent, an azo crosslinking agent, a polyisocyanate crosslinking agent, sulfur and sulfides.

In some embodiments, the adhesion promoter composition may further include a rheology modifier in an amount ranging from 0.1 to 30 wt % with respect to the total weight of the adhesion promoter composition.

In some embodiments, the rheology modifier may include at least one selected from the group consisting of: polyurethane, acrylic polymers, latex, styrene/butadiene, polyvinyl alcohols, cellulosic resins, sulfonates, gums, sacharides, proteins, waxes, organosilicones, modified castor oil, petroleum oil, tall oil, rosin acid, lubricant, process oil, vegetable oil, seed oil, bio-lubricating oil, recycle oil, phthalate, trimellitate, silicon surfactant and a non-meltable component.

In some embodiments, the non-meltable component may include at least one selected from the group consisting of: clay, lime, silica, fume silica, carbon black, cellulose, and fiber.

In some embodiments, the adhesion promoter composition may be in a powder or liquid form.

In some embodiments, the adhesion promoter composition may be applied to an asphalt or a road.

According to an embodiment, an asphalt binder includes: an asphalt; and the adhesion promoter composition.

In some embodiments, the adhesion promoter composition may be included in an amount ranging from 0.1 to 20 wt % with respect to the total weight of the asphalt binder.

In some embodiments, a maximum load at break of the asphalt binder may be more than or substantially equal to 38.0 kgf in an indirect tensile strength (IDT) test according to the ASTM D6931 standard.

In some embodiments, the asphalt binder may satisfy at least one physical property of the following (i) to (iii):
(i) a maximum viscosity (on the basis of 135° C.) according to the ASTM D4402 standard is less than or substantially equal to 500 cps,
(ii) an adhesion strength at which breakage occurs according to the KS L ISO13007-2 standard is more than or substantially equal to 0.50 N/mm², and
(iii) a stripping rate according to the ASTM D3625 standard is less than or substantially equal to 5%.

According to an embodiment, an asphalt mixture includes the asphalt binder, an aggregate and a filler.

In some embodiments, the asphalt binder may be included in an amount ranging from 0.5 to 20 wt % with respect to the total weight of the asphalt mixture.

### Effects of the Invention

According to some embodiments of the present invention, adhesion, cohesion, and rheology required for an asphalt adhesion promoter may all be improved by mixedly using a vinyl acetate-ethylene (VAE)-based redispersible polymer and a wetting agent and by adjusting their content in a predetermined ratio.

In addition, according to some embodiments of the present invention, performance substantially equal to or higher than the performance of a conventionally commercialized liquid amine-based surfactant-type adhesion promoter may be achieved without deteriorating physical properties.

The effects according to various embodiments herein are not limited by the descriptions exemplified above, and more various effects are within the scope of the present specification.

### BRIEF DESCRIPTION OF DRAWINGS

FIG. 1 is a photograph illustrating a change in degree of stripping after precipitation in water using an aggregate coated with asphalt according to the ASTM D3625 test standard.

FIG. 2 is a graph illustrating results of adhesion between an asphalt mixture and an aggregate concrete slab lower surface according to the KS L ISO13007-2 test standard.

FIG. 3 is a graph illustrating viscosity properties of an asphalt film according to the ASTM D4402 test standard.

FIG. 4 is a graph illustrating indirect tensile strength (IDT) properties of an asphalt mixture according to the ASTM D6931 test standard.

### MODES FOR CARRYING OUT THE INVENTION

Hereinafter, the present invention will be described in detail. However, the present invention is not limited only by the following descriptions, and each component may be variously modified or selectively used as necessary. Therefore, it should be understood that the present invention of the present invention encompasses all modifications, equivalents, and substitutes within the spirit and scope of the present invention.

Unless defined otherwise, all terms (including technical and scientific terms) used herein may be interpreted as those commonly understood by those of ordinary skill in the art to which the present invention belongs. In addition, terms defined in a common dictionary are not interpreted ideally or excessively unless explicitly defined otherwise.

As used herein, the term “composition” includes not only mixtures of materials including the composition but also reaction products and decomposition products generated from the materials of the composition. In addition, the term “polymer”, as used herein, refers to a polymeric compound prepared by polymerizing monomers whether of the same kind or different kinds. Accordingly, “polymer” as used herein includes both of a homopolymer (refer to a polymer made from only one kind of monomer, while understanding that a small amount of impurities may be incorporated into the polymer structure), and a copolymer as defined hereinbelow. In an example, the polymer may optionally include copolymers, terpolymers, tetrapolymers, pentapolymers, etc., that are a polymer made from one or more different monomers, and may mean any of a random, block, graft, sequential or gradient polymer.

In addition, throughout the present invention, when a certain part “includes” a certain component, it means that another component may be further included, rather than excluding other components, unless stated otherwise. In addition, the terms ‘about’, ‘substantially’, etc. used to express the degree in the present invention are only used for the meaning of or close to the numerical value with manufacturing and material tolerances, and the present invention is not limited to the specific numerical value.

Conventional surfactant-type adhesion promoters are in a liquid form and have tacky surface properties. These surfactant-type adhesion promoters have high adhesion between asphalt and aggregate and excellent rheology, but when the content is increased beyond a predetermined range, cohesion of the asphalt binder itself is lowered such that it is difficult to exhibit rigidity.

Accordingly, the present invention is directed to provide a novel adhesion promoter composition capable of sufficiently providing rigidity by securing high cohesion of the asphalt binder itself, while maintaining adhesion and rheology substantially equal to or higher than that of conventional surfactant-type adhesion promoters.

<Adhesion Promoter Composition>

An adhesion promoter composition according to an embodiment is an adhesion promoter composition that is applied to common asphalt, concrete road pavement, etc. known in the art to improve and enhance adhesion.

For example, the adhesion promoter composition is a liquid or powdery composition which includes vinyl acetate-ethylene (hereinafter, “VAE”)-based redispersible polymer powder; and a wetting agent, and contents of them are adjusted within a predetermined range. If necessary, at least one of common rheology modifier and crosslinking agent known in the art may be further included, and other common additives may be optionally included.

Hereinafter, the composition of the adhesion promoter composition will be described in detail.

VAE-Based Redispersible Polymer

The adhesion promoter composition according to an embodiment includes a VAE-based dispersible polymer powder (e.g., a VAE-based dispersible polymer powder) having excellent adhesion performance and environmental friendliness.

In an embodiment, the VAE-based redispersible polymer includes a VAE copolymer and a filler.

The VAE copolymer includes a vinyl acetate (hereinafter, “VA”) polymerization unit and an ethylene polymerization unit that are known in the art, and any VAE copolymer including the VA in an amount more than 50 percent by weight (wt %) with respect to the total weight of the polymer may be used without limitation.

The redispersible polymer powders are based, in general, on vinyl acetate/ethylene (VAE) copolymers having a vinyl acetate content of more than 50 wt %, preferably 52 wt %, more preferably 55 wt %, and an ethylene content of less than 50 wt %, preferably 1 to 40 wt %, and optionally further monomers copolymerizable therewith, in each case based on the total weight of the monomer mixture, and the figures in wt % totaling 100 wt % in each case. According to an exemplary embodiment of the present invention, the vinyl acetate-ethylene (VAE) copolymer has a vinyl acetate (VA) content of more than 50 wt % and 99 wt % or less; and an ethylene content of 1 wt % or more and less than 50 wt % based on the total weight of the vinyl acetate/ethylene (VAE) copolymer.

Suitable further vinyl ester monomers are vinyl higher esters, for example those of carboxylic acids having 3 to 15 Carbon atoms. Suitable further monomers from the group of acrylic esters or methacrylic esters include, for example, esters of unbranched or branched alcohols having 1 to 15 Carbon atoms. Preferred vinylaromatic further monomers are styrene, methylstyrene, and vinyltoluene. A preferred vinyl halide further monomer is vinyl chloride. The preferred olefin further monomers are propylene and butylene, and the preferred dienes are 1,3-butadiene and isoprene.

Optionally, it is also possible for 0.1 to 10 wt % of auxiliary monomers to be copolymerized, based on the total weight of the monomer mixture. Preference is given to using 0.1 to 5 wt % of optional auxiliary monomers. Examples of optional auxiliary monomers are ethylenically unsaturated monocarboxylic and dicarboxylic acids, ethylenically unsaturated carboxamides and carbonitriles, and also maleic anhydride, and ethylenically unsaturated sulfonic acids and their salts. Other examples of optional auxiliary monomers are precrosslinking comonomers such as polyethylenically unsaturated comonomers, or post crosslinking comonomers, examples being N-methylolacrylamide (NMA), and N-methylolmethacrylamide (NMMA). Also suitable are epoxide-functional comonomers such as glycidyl methacrylate and silicon-functional comonomers, such methacryloyloxypropyltrialkoxysilanes, and vinyltrialkoxysilanes.

Preference is given to copolymers of 60 to 99 wt % of vinyl acetate with 1 to 40 wt % of ethylene;

Copolymers of more than 50 wt % of vinyl acetate with 1 to 40 wt % of ethylene and one or more further comonomers from the group of the vinyl esters having 1 to 12 carbon atoms in the carboxyl radical, such as vinyl propionate, vinyl laurate, and vinyl esters of alpha-branched carboxylic acids having 5 to 12 carbon atoms, such as VeoVa9® and VeoVa10®;

Copolymers of more than 50 wt % of vinyl acetate, 1 to 40 wt % of ethylene and one or more further comonomers from the group of (meth)acrylic esters of unbranched or branched alcohols having 1 to 15 carbon atoms, especially methyl methacrylate, methyl acrylate, n-butyl acrylate and 2-ethylhexyl acrylate; where the copolymers may each also contain the auxiliary monomers mentioned in the amounts mentioned, and the figures in wt % total 100 wt % in each case.

The monomer selection and the selection of the weight fractions of the comonomers are preferably selected so as to result in glass transition temperatures, Tg, ranging from −40° C. to +25° C., and more preferably −20° C. to +20° C. The Tg of the polymers can be determined in a known way by means of Differential Scanning calorimetry (DSC, DIN EN ISO 11357-1/2), for example determined with a calorimeter DSC from Mettler-Toledo, with a heating rate of 10 K/min as midpoint temperature. The Tg may also be calculated approximately in advance using the Fox formula. According to Fox T. G., Bull. Am. Physics Soc. 1, 3, page 123 (1956) the following is the case: 1/Tg=x1/Tg1+x2/Tg2+ . . . +xn/Tgn, where xn stands for the mass fraction (wt %/100) of the monomer n, and Tgn is the glass transition temperature, in degrees Kelvin, of the homopolymer of the monomer n. Tg values for homopolymers are listed in Polymer Handbook 2nd Edition, J. Wiley & Sons, New York (1975).

The polymers are prepared generally in an aqueous medium and preferably by the emulsion or suspension polymerization process, as described for example in WO 2010/057888 A1. The polymers in that case are obtained in the form of aqueous dispersions. In the polymerization, it is possible to use the customary protective colloids and/or emulsifiers, as described in WO 2010/057888 A1.

As protective colloids preference is given to partially hydrolyzed or fully hydrolyzed polyvinyl alcohols, having a degree of hydrolysis of 80 to 100 mol-%, more particularly to partially hydrolyzed polyvinyl alcohols having a degree of hydrolysis of 80 to 94 mol-% and a Floppier viscosity, in 4% strength aqueous solution, of 1 to 30 mPas (Höppler method at 20° C., DIN 53015). The stated protective colloids can be obtained by methods known to the skilled person, and are added generally in an amount of in total 1 to 20 wt %, based on the total weight of the monomers, in the polymerization.

The polymers in the form of aqueous dispersions will be dried in a conventional manner. In a preferred embodiment the polymers may be converted to water-dispersible polymer powders by the spray-drying process, as described in WO 2010/057888 A1, for example. In that case it is usual to add a drying aid in a total amount of 3 to 30 wt %, based on the polymeric constituents of the dispersion. Preferred drying aids are the abovementioned polyvinyl alcohols. Additionally, anti-blocking agent may be added during or after the drying step.

The polymer powders are commercially available, for example as Vinnapas® and ETONIS® dispersion powders of Wacker Chemie AG.

The vinyl acetate/ethylene polymers may also be prepared by other methods, including solution polymerization, or bulk (neat) polymerization. Polymers prepared by solution or bulk polymerization are preferably supplied in a form having a relatively high surface area. For this purpose, for example, the polymers may be extruded into pellets or granules by conventional processes or otherwise prepared in small particle sizes. The use of water-dispersible powders resulting from emulsion or suspension polymerization followed by drying, in particular, spray drying, reduces asphalt blending time significantly, and thus water dispersible powders are highly preferred.

In an embodiment, the vinylacetate-ethylene (VAE)-based copolymer is in the form of solid powder, but because it is composed of polymer, surface cohesion is high and the particle size is not uniform and may be coarsened. In order to have a uniform powder size and shape, the vinylacetate-ethylene (VAE)-based redispersible polymer powder may include a filler.

The filler may use any conventional filler known in the art without limitation, and may be, for example, an inorganic filler, an organic filler, or a mixture thereof.

Non-limiting examples of the inorganic fillers may include silica, alumina, barium sulfate, calcium carbonate (CaCO₃), magnesium hydroxide, alumina hydroxide, titanium dioxide, clay, mica, wollastonite, talc, magnesium carbonate, carbon black, graphite, carbon nanotubes, or nanosilver. The above-mentioned components may be used singly or in combination of two or more. It may preferably be calcium carbonate.

Non-limiting examples of the organic filler may include organic bentonite, polyethylene wax, polypropylene wax, polymethyl methacrylate, polyurethane, silicone resin powder, micronized polyamide, styrene-ethylene/butylene-styrene block copolymers, and rosin esters. These may be used singly or in combination of two or more.

An average particle diameter D50 of the filler is not particularly limited, and may be appropriately adjusted within a range of the ordinary particle size applicable in the art. For example, the average particle diameter D50 of the filler may be in a range from 1 μm to 30 μm, specifically in a range from 1 μm to 20 μm. A shape of the filler is not particularly limited, and examples thereof may include spherical, granular, plate, scaly, whisker, rod, filament, or irregular shapes. The inorganic particles having such shapes may be used singly or in combination of two or more. In addition, the filler may also be coated with a surface treating agent such as a coupling agent and a conventional polymer.

A content of the filler is not particularly limited, and may be appropriately adjusted in consideration of the uniformity and physical properties of the vinylacetate-ethylene (VAE)-based redispersible polymer powder. For example, the filler may be included in an amount from 0.1 to 30 wt %, specifically in a range from 1 to 20 wt %, with respect to the total weight (e.g., 100 wt %) of the vinylacetate-ethylene (VAE)-based dispersible polymer powder.

In the adhesion promoter composition according to an embodiment, the content of the VAE-based redispersible polymer powder is not particularly limited, and, for example, may be in a range from 30 to 95 wt %, and specifically, 35 to 90 wt %, with respect to the total weight (e.g., 100 wt %) of the adhesion promoter composition. When the content of the VAE-based redispersible polymer powder falls within the above-described numerical range, excellent adhesion, compactness, rheology, and workability may be provided without deteriorating physical properties.

Wetting Agent

The adhesion promoter composition according to an embodiment includes a wetting agent.

The wetting agent serves uniform and stable dispersion between raw materials in the process of mixing with other raw materials and serves to improve storage stability and workability by lowering viscosity. In addition, the wetting agent adsorbed onto or surrounding surfaces of the raw materials prevents re-aggregation by maintaining a substantially constant gap between the raw materials that may occur due to electrostatic repulsion or steric hindrance effect.

Any wetting agent or dispersion stabilizer known in the art may be used as the wetting agent without limitation, for example, an anionic wetting agent and/or a water-based wetting agent such as a non-ionic wetting agent. Non-limiting examples of applicable wetting agents may include, for example, sodium polyacrylate, saponified product of styrene (or olefin) maleic anhydride copolymer, sodium alkylnaphthalene sulfonic acid-formalin condensate, sodium ligninsulfonate, polyethylene glycol phenyl ether, polyethylene glycol higher alkyl, ether dialkyl sulfosuccinate, alkyl amine, alcohol amine, polyethyleneimine, sorbitan aliphatic ethylene oxide adduct, or mixtures thereof. Specifically, an alkyl amine-based wetting agent may be used.

In the adhesion promoter composition according an embodiment, a content of the wetting agent is not particularly limited, and may be appropriately adjusted within the content range known in the art. For example, the wetting agent may be included in an amount ranging from 0.1 to 50 wt %, and specifically 0.5 to 45 wt %, with respect to the total weight (e.g., 100 wt %) of the adhesion promoter composition.

In an embodiment of the present invention, by appropriately controlling the content of the wetting agent, effects of improvement in adhesion, cohesion, and rheology may be provided, and formulation may be freely modified. For example, when the content of the wetting agent is in a range from 40 to 50 wt %, the adhesion promoter composition may be a gel-type liquid formulation even though it does not contain a solvent. In addition, when the content of the wetting agent is less than 40 wt %, it may have a solid powder formulation.

Crosslinking Agent

The composition for adhesion promoter according to an embodiment may further include a common crosslinking agent known in the art.

The composition for adhesion promoter according to an embodiment of the present invention may further include a conventional crosslinking agent known in the art.

The crosslinking agent is a material that is present in an unreacted state at room temperature and initiates a crosslinking reaction to form a crosslinked structure when it is included in an asphalt mixture and a high temperature is applied thereto. The crosslinking agent according to the present invention may use a conventional thermosetting crosslinking agent known in the art, and may include, for example, at least one selected from the group consisting of an organic peroxide crosslinking agent, a silane crosslinking agent, an azo crosslinking agent, a polyisocyanate crosslinking agent, sulfur and a sulfide.

Non-limiting examples of a crosslinking agent may include dicumyl peroxide (DCP), dibenzoyl peroxide (DBP), methyl-ethyl-ketone peroxide (MEKP), t-butyl peroxybenzoate, di-2-ethylhexyl peroxyneodecanoate, t-butyl peroxypivalate, di-isopropyl peroxydicarbonate, bis (2,4-dichlorobenzoyl) peroxide, 1,1-bis (t-butylperoxy)-3,3,5-trimethyl chlorohexane, 2,5-dimethyl-2,5-bis (t-butylperoxy) hexane, t-butyl peroxyneodecanoate, t-butyl peroxy-2-ethylhexanoate, di-3-methoxybutyl peroxydicarbonate, di-3,5,5-trimethylhexanonyl peroxide, t-butylperoxy acetate, sulfur or sulfide. The above-mentioned components may be used singly or in combination of two or more. Preferably, it may be sulfur or sulfide. Examples of the sulfur may include natural sulfur, a sulfur substance produced by desulfurization of petroleum or natural gas, or modified sulfur in which general properties of sulfur are modified by, for example, dicyclopentadiene (DCPD).

In the adhesion promoter composition according to an embodiment, a content of the crosslinking agent is not particularly limited, and may be appropriately adjusted within a range known in the art. For example, the crosslinking agent may be in a range from 0.1 to 15 wt %, specifically 0.1 to 12 wt %, with respect to the total weight (e.g., 100 wt %) of the adhesion promoter composition. If the content of the crosslinking agent is less than 0.1 wt %, the effect that may be obtained by using the crosslinking agent is insignificant, and the crosslinking reaction does not occur smoothly. If the content exceeds 15 wt %, melting does not occur at a temperature above a melting point due to crosslinking, thus making it difficult to manufacture a product of uniform quality.

Rheology Modifier

The adhesion promoter composition according to an embodiment may further include a common rheology modifier known in the art.

The rheology modifier is added to the composition to improve viscosity and rheology. Any common fluidizing agent or viscosity improving agent known in the art may be used as the rheology modifier without limitation. Examples of the rheology modifier may include a low molecular weight anionic polymer, a high molecular weight polymer, mixtures of a low molecular weight anionic polymer and a high molecular weight polymer, mixtures of a chelating agent and a high molecular weight polymer, and mixtures of a chelating agent, a high molecular weight polymer, and a low molecular weight anionic polymer, waxes, alcohols, polyols, or mixtures thereof.

Non-limiting examples of the rheology modifier may include, for example, polyurethane, acrylic polymers, latex, styrene/butadiene, polyvinyl alcohols, cellulosic resins, sulfonates, gums, sacharides, proteins, waxes, organosilicones, modified castor oil, petroleum oil, tall oil, rosin acid, lubricants, process oil, vegetable oil, seed oil, bio-lubricating oil, recycle oil, phthalate, trimellitate, silicon surfactant, a non-meltable component, or mixtures thereof.

The non-meltable component is not particularly limited, and may include, for example, at least one selected from the group consisting of: clay, lime, silica, fume silica, carbon black, cellulose, and fiber.

In the adhesion promoter composition according to an embodiment, a content of the rheology modifier is not particularly limited, and may be appropriately adjusted within a range known in the art. For example, the content of the rheology modifier may be in a range from 0.1 to 30 wt %, and specifically 0.1 to 28 wt %, with respect to the total weight (e.g., 100 wt %) of the adhesion promoter composition. When the content of the rheology modifier falls within the above-described numerical range, rheology may be improved without deteriorating physical properties.

Additive

In addition to the above-described components, the adhesion promoter composition according to an embodiment may use at least one additive known in the art, without limitation, within a range that does not impair the effect of the present invention.

Examples of applicable additives may include catalysts, additional adhesion promoters (which are different from VAE-based polymer adhesion promoters), moisture removers, hardeners, pH neutralizers, plasticizers, compatibilizers, fillers (such as functional fillers, silica-based fillers, and mineral-based fillers, pigments/dyes, and/or crosslinking agents. The content of these additives may be appropriately adjusted within a range known in the art, and is not particularly limited. For example, the at least one additive may be included in an amount ranging from 0.01 to 5 wt %, and specifically 0.01 to 2 wt %, with respect to the total weight of the adhesion promoter composition.

The adhesion promoter composition according to an embodiment may be prepared by mixing the above-described VAE-based redispersible polymer powder and wetting agent with, when necessary, the crosslinking agent and the rheology modifier, and then by mixing and stirring them according to a common method known in the art. If necessary, other additives or solvents may be further added.

The mixing method is not particularly limited, and in an embodiment, common mixers known in the art, such as homogenizers, homo dispersers, homo mixers, universal mixers, planetary mixers, kneaders and the like, may be used. In addition, the mixing conditions are not particularly limited, and for example, the adhesion promoter composition may be prepared by mixing for 0.1 to 3 hours under a temperature condition ranging from 20 to 180° C.

The adhesion promoter composition according to an embodiment configured as described above may include 30 to 95 wt % of the VAE-based redispersible polymer powder, 0.1 to 50 wt % of the wetting agent, 0.1 to 15 wt % of the crosslinking agent; and 0.1 to 30 wt % of the rheology modifier, with respect to the total weight of the composition. Additives or solvents in the art may be additionally included if necessary, and contents thereof may be a remaining amount to satisfy the total weight (100 wt %) of the composition.

A formulation of the adhesion promoter composition according to an embodiment is not particularly limited, and for example, may be a powder type or a gel-type liquid. For example, when the content of the wetting agent is less than 40 wt %, it may be a solid powder formulation. On the other hand, when the content of the wetting agent is in a range from 40 to 50 wt %, the adhesion promoter composition may be a gel-type liquid formulation even if it does not contain a solvent.

<Asphalt Binder>

The asphalt binder according to an embodiment may be a general asphalt and/or a polymer-modifying asphalt mixture (or an asphalt composition) including the above-described adhesion promoter composition.

In an embodiment, the asphalt binder includes an asphalt; and the above-described adhesion promoter composition.

Any asphalt component as long as it is an asphalt commonly used in an asphalt mixture may be used without particular limitation, for example, natural asphalt, petroleum-based asphalt, asphalt mixture or cement concrete pavement. Suitable kinds of asphalt for use in the present invention are those commonly used in any of the applications listed above, such as, but not limited to, asphalt reflected by the three systems typically used to grade asphalt: penetration grading system (ASTM D D946/D946M-09a) (“penetration grade”), viscosity grading system (ASTM D3381-09) (“viscosity grade”) and the commonly used system in the U.S., the performance grading system (ASTM D6373-15) (“performance grade”).

The asphalt used in the present invention also includes, but is not limited to, natural products such as lake asphalt, gilsonite, and natural rock asphalt. Further, it includes crude petroleum residues, such as, but not limited to, paraffin base, mixed base, and asphalt base. The asphalt base further includes, for example, asphalt cements, oxidized asphalts and liquid asphalts, which further includes cutbacks and road oils and emulsions, or any of the above combinations thereof. Still further, the bituminous materials used in the present invention include, tars, for example, from a coal destructive distillation and cracking of petroleum vapors or any combinations thereof.

While the composition of the asphalt binder depends on the end-use application and the required properties, it generally includes 85 to 99.9% by weight, preferably 90 to 99.7% by weight of the asphalt, and more preferably 93 to 99.7% by weight of asphalt, in each case based on the total weight of the asphalt binder.

In general, the asphalt binder is obtained by the addition of 0.1 to 20% by weight, preferably 0.3 to 15% by weight, and more preferably 0.5 to 12% by weight of vinylacetate-ethylene (VAE)-based dispersible polymer adhesion promoter, in each case based on the total weight of the asphalt binder.

In addition to the above-described components, the asphalt binder according to an embodiment may further include a common polymer modifier known in the art.

In general, polymer-modifying additives may be classified into a rubber type, a thermoplastic resin type, a thermoplastic elastomer type, a copolymer type, a anti-stripping type, a compactness-enhancing additive type, and a rheology-improving type.

Examples of the rubber type include natural rubber, polybutadiene rubber, polyisoprene rubber, isobutylene-isoprene rubber, polychloroprene rubber, and the like. In addition, examples of the thermoplastic resin type may include polyethylene, polypropylene, polystyrene, nylon, acrylic, polyvinyl chloride and the like. In addition, examples of the thermoplastic elastomers (TPES) may include: styrenic block copolymers (SBC), thermoplastic polyolefin elastomers (TPO), thermoplastic vulcanizates (TPV), thermoplastic polyurethanes (TPU), thermoplastic copolyester (TPC), thermoplastic polyamides (TPA), other non-classified thermoplastic elastomers (TPZ), and the like. In addition, examples of the copolymer type may include acrylonitrile butadienestyrene (ABS) resins, styrene/butadiene rubber (SBR) copolymers, styrene butadienestyrene (SBS) copolymers, nitrile butadienerubber (NBR), styrene-acrylonitrile (SAN), styrene-isoprenestyrene (SIS), ethylene-vinyl acetate (EVA), vinyl acetate-ethylene (VAE), and the like. In addition, examples of the anti-stripping type may include amine-based surfactants, and examples of compactness and rheology improving agents may include natural vegetable oils, mineral oils, synthetic process oils, and the like. The aforementioned components may be used alone or two or more types thereof may be used in combination.

The selection of other additives and the proportion thereof is state of the art and is well-known to the skilled worker. These additives include, but not limited to, hydrocarbon resins, pitch pine, rosin esters, extender oils, naphthalenic or paraffinic oils, acids such as phosphoric or polyphosphoric acid, polyamines, stabilizers, solvents, waxes, etc., or combinations thereof.

Further, additives which may be added are fillers like limestone, chalk, graphite, talc, fly ash, quartz powder, glass fiber or cellulose fiber. The selection of filler and the amount of filler used in the asphalt binder (polymer-modified asphalt mixture) depends on the intended use of the asphalt binder and is well known to the skilled worker.

Further examples of conventional additives may include anti-aging agents, corrosion inhibitors, biocides, pigments or processing aids, such as, for example, lubricants. The general amount is defined by both the application and the use of other polymers and is well known to the skilled worker.

The preparation of the asphalt binder has no special limitations and is carried out in the manner known from the prior art. Usually, all components are intensively mixed in an agitated vessel at elevated temperatures of 155° C. to 195° C. The material obtained is then further processed depending on the intended use. The blend may be processed, for example by calendering or other suitable technologies such as coating, grinding, lubricating, spreading, laminating, extrusion etc.

The asphalt binder can be used for the production of asphalt sheets for waterproofing application, paving, sealing, drainage, roofing, etc.

The asphalt binder according to an embodiment, configured as described above, may secure both of high cohesion and excellent rheology of the asphalt binder itself, while maintaining adhesion between asphalt and aggregate. In particular, the asphalt binder according to an embodiment may provide higher cohesion, as compared to a case where a common surfactant-type adhesive is applied, thus improving rigidity.

In an embodiment, the asphalt binder may have a maximum load (i.e., force) more than or substantially equal to 38.0 kgf, specifically in a range from 38.0 to 350 kgf, and more specifically in a range from 38.0 to 320 kgf, at break of a specimen in an indirect tensile strength (IDT) test according to the ASTM D6931 standard.

In another embodiment, the asphalt binder may satisfy at least one or more of the following physical property conditions (i) to (iii), and specifically, it is preferable to satisfy all of the physical properties of (i) to (iii). For example, (i) an asphalt coating anti-stripping rate according to the ASTM D3625 standard is less than or substantially equal to 5%, specifically in a range from 0 to 5.0%. In addition, (ii) a maximum viscosity (based on 135° C.) according to the ASTM D4402 standard is less than or substantially equal to 500 cps, specifically in a range from 10 to 200 cps. In addition, (iii) an adhesion strength at break according to the KS L ISO13007-2 standard is more than or substantially equal to 0.50 N/mm², specifically in a range from 0.52 to 10.00 N/mm², and more specifically in a range from 0.66 to 8.00 N/mm².

<Asphalt Mixture>

An asphalt mixture or asphalt composition according to an embodiment includes the above-described asphalt binder, aggregate, and filler.

The aggregate is not particularly limited as long as it is an aggregate commonly used in an asphalt mixture. For example, the aggregate may include coarse aggregate, fine aggregate, crushed stone (crushed aggregate), sand, gravel, screenings, stone powder, recycled aggregate, or mixtures thereof. A fiber reinforcement agent or a packing filler may be optionally added to the aggregate.

Herein, the coarse aggregate and the fine aggregate may be classified according to the size of the particles, and the types are not particularly limited. For example, the coarse aggregate may use crushed coarse aggregate having a particle size of more than 5 mm and less than or substantially equal to 13 mm. The coarse aggregate may increase unit density and enhance strength by making the asphalt mixture compact, while substantially minimizing voids between the aggregates. In addition, the fine aggregate may use crushed aggregate having a particle size in a range from 0.3 mm to 5 mm. The fine aggregate may increase the strength by filling the voids of the coarse aggregate to increase the unit density of the asphalt mixture. The fine aggregate may use crushed sand, natural sand, or mixtures thereof obtained by breaking rocks or gravel. The fine aggregate is configured to be clean and durable, and not to contain harmful substances such as dust, clay, and organic matter. In an embodiment, a use ratio of the coarse aggregate and the fine aggregate is not particularly limited, and may be appropriately adjusted within a typical range known in the art. For reference, the particle size and quality of the aggregate used in the asphalt mixture may be in accordance with the KS F 2357 standard. A content of the aggregate is not particularly limited, and may be appropriately adjusted within a typical content range known in the art. For example, the aggregate may be included in an amount ranging from 60.0 to 99.0 wt %, specifically 65.0 to 98.0 wt %, with respect to the total weight of the asphalt mixture.

In addition, a filler is added to improve adhesion strength and durability by filling the voids formed between the aggregates. The filler is not particularly limited in its type and shape as long as it is a common filler used in the field of the asphalt mixture. For example, one or more type selected from the group consisting of limestone powder, Portland cement, slaked lime, fly ash, and recovered dust may be used. Other than that, various types of incineration ash, blast furnace slag, electric furnace steelmaking dust, other suitable mineral powders, or mixtures thereof may also be used. It is preferable to use ones in which harmful substances such as dust, mud, organic matter, and lumpy particles have been removed. Slaked lime may be used in consideration of ease of use and strength characteristics. A content of the filler is not particularly limited, and may be appropriately adjusted within a typical content range known in the art. For example, the filler may be included in an amount ranging from 0.5 to 30.0 wt %, specifically 0.5 to 25.0 wt %, with respect to the total weight of the asphalt mixture.

In addition, the asphalt binder serves to crosslink the aggregate, the filler, and the like constituting the aforementioned asphalt mixture to be firmly bonded with each other. In particular, the asphalt binder according to an embodiment is different from a conventional asphalt binder in that it has a synergy effect of improving adhesion along with cohesion between each component constituting the asphalt mixture, while maintaining adhesion and rheology more than or substantially equal to those of a common surfactant-type adhesion promoter. Since such an asphalt binder has a composition substantially the same as that of the aforementioned asphalt binder, additional descriptions thereof will be omitted. A content of the asphalt binder is not particularly limited, and may be appropriately adjusted within a typical content range known in the art. For example, the asphalt binder may be included in an amount ranging from 0.5 to 20.0 wt %, specifically 1.0 to 15.0 wt %, with respect to the total weight of the asphalt mixture.

The asphalt mixture according to an embodiment may further include other additives, such as other modifiers, fibers, elastic materials, process oils, plasticizers, waxes, corrosion inhibitors, reinforcing agents, etc. not described above, as long as the inherent properties thereof are not impaired.

The aforementioned asphalt mixture according to an embodiment may be used as a building material such as asphalt, concrete road paving material, or waterproofing material. In addition to the above-described technical fields, it may be applied without limitation to various fields requiring high adhesion and cohesion and excellent rheology.

Hereinafter, the present invention will be described in detail through embodiments. However, the following embodiments are only illustrative of the present invention, and the present invention is not limited by the following embodiments.

### Embodiments 1 and 2. Adhesion Promoter Composition

A VAE-based redispersible polymer powder [solid dispersible polymer powder (DPP), Wacker Chemie AG], a wetting agent [alcohol amine-type chemical, Samchun Chemicals] and a vulcanization crosslinking agent [sulfuric crosslinking agent, Junsei Chemical Co., Ltd.] were added at a predetermined weight ratio as shown in the following Table 1 and then mixed for 1 hour at a temperature ranging from 20 to 80° C. using a mixer to prepare adhesion promoter compositions of Embodiments 1 and 2. In Table 1 below, a mixing ratio of each composition is in wt %.

TABLE 1

| | Embodiment 1 | Embodiment 2 |
|---|---|---|
| Component | (WCK AP-1) | (WCK AP-2) |
| VAE-based redispersible polymer | 84 | 49 |
| powder (DPP) | | |
| Wetting agent | 15 | 50 |
| (Alcohol amine-type chemical) | | |
| Crosslinking agent | 1 | 1 |
| (Sulfuric crosslinking agent) | | |
| Total amount (wt %) | 100 | 100 |

[Evaluation of Physical Properties of Asphalt Binder]

An asphalt binder to which the adhesion promoter composition according to an embodiment was applied was evaluated in terms of adhesion, cohesion, and rheology properties.

Specifically, after sufficiently melting an asphalt at 150° C., materials of Table 1 were added to the asphalt melt and stirred for at least 1 hour at about 150° C. at 300 rpm until sufficiently melted to prepare asphalt binders, respectively. In the following Table 2, a mixing ratio of each composition is in wt %.

In order to evaluate adhesion of the asphalt binder prepared above, a stripping rate of the asphalt binder coating material and an adhesion with the asphalt mixture were evaluated. In addition, a viscosity of the asphalt binder was measured in order to evaluate the rheology. In addition, an adhesion of the asphalt mixture was evaluated in order to identify the cohesion.

TABLE 2

| | | Mixing ratio of asphalt binder (wt %) | | | |
|---|---|---|---|---|---|
| No. | Composition | Exp 1 | Exp 2 | Exp 3 | Exp 4 |
| 1 | Asphalt | 100.0 | 99.5 | 99.5 | 99.5 |
| | (AP-5:PG64-22) | | | | |
| 2 | Surfactant adhesion | 0.0 | 0.5 | 0.0 | 0.0 |
| | promoter (Wetfix BE, | | | | |
| | Akzo nobel) | | | | |
| 3 | Adhesion promoter | 0.0 | 0.0 | 0.5 | 0.0 |
| | composition of | | | | |
| | Embodiment 1 (WCK | | | | |
| | AP-1) | | | | |
| 4 | Adhesion promoter | 0.0 | 0.0 | 0.0 | 0.5 |
| | composition of | | | | |
| | Embodiment 2 (WCK | | | | |
| | AP-2) | | | | |
| | Total amount | 100.00 | 100.00 | 100.00 | 100.00 |

### Experimental Embodiment 1. Evaluation of Stripping Rate of Asphalt Coating

Coating resistance of the VAE-based polymer adhesion promoter composition according to an embodiment was evaluated as follows.

Specifically, the asphalt binder and the aggregate prepared according to the conditions of Table 2 were added at a predetermined mixing ratio and stirred for at least 5 minutes until the aggregate was sufficiently coated to prepare asphalt mixtures, respectively (see Table 3 below).

A stripping experiment was conducted according to the ASTM D3625 “Standard Practice for Effect of Water on Bituminous-Coated Aggregate Using Boiling Water”. As an example, 250 g of the aggregate coated with the asphalt binder was immersed in water for about 10 minutes at about 85° C. and then taken out to remove moisture, the aggregate sample was then spread out on white paper, and whether or not the asphalt coating on the aggregate surface had been stripped was observed with the naked eye. After observation with the naked eye, a stripping rate (%) represented by Formula 1 was calculated, and the results are shown in Table 3 below.

Stripping rate (%)=(A/B)×100 [Formula 1]

In the above Formula 1, A is the number of aggregates in which stripping occurred among the total aggregates coated with the asphalt binder after the stripping experiment was conducted, and B is the total number of aggregates coated with the asphalt binder used in the stripping experiment. It means that the lower the stripping rate, the less the number of aggregates in which the coating is stripped off by water immersion, indicating that the stripping resistance by water immersion is excellent.

As a result of the experiment, in the case of a general asphalt coating (Exp 1) containing no adhesion promoter, a coating stripping rate was 10%. In addition, in the case of an asphalt binder (Exp 2) to which the conventional surfactant-type adhesive was applied, the coating stripping rate was as low as about 2%, indicating that the stripping resistance was improved.

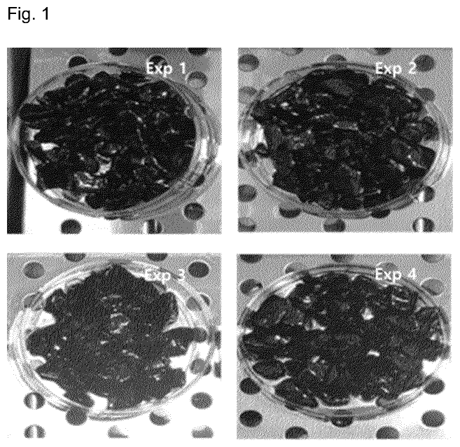

In an embodiment, in the case of an asphalt binder (Exp 3) of Embodiment 3 to which the VAE-based polymer adhesion promoter was applied exhibited a low coating stripping rate of 2%. Specifically, it was appreciated that the asphalt binder of Embodiment 3 exhibited excellent strip resistance by reducing the stripping rate by about 80% as compared to the general asphalt (Exp 1), and exhibited adhesion properties at a level substantially equal to that of the asphalt binder (Exp 2) to which a conventional representative surfactant-type adhesive was applied. In addition, in the case of an asphalt binder (Exp 4) of Embodiment 4, a coating stripping rate was 5%, which was reduced by about 50% as compared to the general asphalt (Exp 1), and thus it was identified that the stripping resistance was significantly improved (See Table 3 and FIG. 1 below).

TABLE 3

| | | | Mixing ratio of asphalt mixture (wt %) | | | |
|---|---|---|---|---|---|---|
| | | | 1 | 2 | 3 | 4 |
| Asphalt | Aggregate | | 95.2 | 95.2 | 95.2 | 95.2 |
| mixture | (13 mm aggregate) | | | | | |
| | Asphalt | Exp 1 | 4.8 | | | |
| | binder | Exp 2 | | 4.8 | | |
| | | Exp 3 | | | 4.8 | |
| | | Exp 4 | | | | 4.8 |

| | | | | | |
|---|---|---|---|---|---|
| Physical | Stripping rate (%) | 10 | 2 | 2 | 5 |
| properties | | | | | |

### Experimental Embodiment 2. Evaluation of Adhesion Strength of Asphalt Binder Composition

In order to evaluate adhesion properties of the asphalt binder to which the VAE-based polymer adhesion promoter composition according to an embodiment is applied, adhesion was measured according to an experiment method based on KS L ISO13007-2.

In order to prepare an adhesion test specimen, pre-melting was performed on the asphalt binders prepared in Table 2 at about 140° C. A concrete slab having a size of 40 cm×40 cm×3.5 cm was prepared for a specimen molding, and then a silicone mold having an area of 5 cm×5 cm was placed. Thereafter, the heated asphalt binder was applied to a thickness of 0.3±0.1 mm to the area of 5 cm×5 cm in the silicone mold, and then cured for 24 hours until the asphalt binder was sufficiently cured. After removing the silicone mold, double components adhesives (CEMEDINE, High Super 5, CA-186) was applied to a surface of the asphalt binder, and an adhesion test jig having an area of 5 cm×5 cm and a thickness of at least 1 cm was attached. According to the specifications of the applied adhesive, it was sufficiently cured for at least 6 hours, and the test specimen on which the final curing was completed was subjected to an adhesion test [tensile adhesion strength (TAS)] according to KS L ISO13007-2. As for the test conditions, a tensile rate was increased at a constant rate of 250±50 N/s to measure the adhesion strength of the adhesive, and each adhesion strength (Sa) was calculated by Formula 2 below and expressed up to 0.1 N/mm².

$${S}_{a} = \frac{F}{A} \qquad [ Formula 2 ]$$

In the above formula, Sa is an adhesive strength (N/mm²), F is a maximum load (N), and A is an area of a bonding site (for example, 2,500 mm²).

As a result of the experiment, the general asphalt (Exp 1) containing no adhesion promoter exhibited a maximum adhesion strength of 0.513 N/mm² until breakage. In addition, in the case of the asphalt binder (Exp 2) to which a conventional representative surfactant-type adhesive was applied, it was 0.659 N/mm², which is higher than that of the general asphalt (Exp 1), thus exhibiting effects of adhesion improvement of about 28.5%, as compared to the general asphalt (Exp 1).

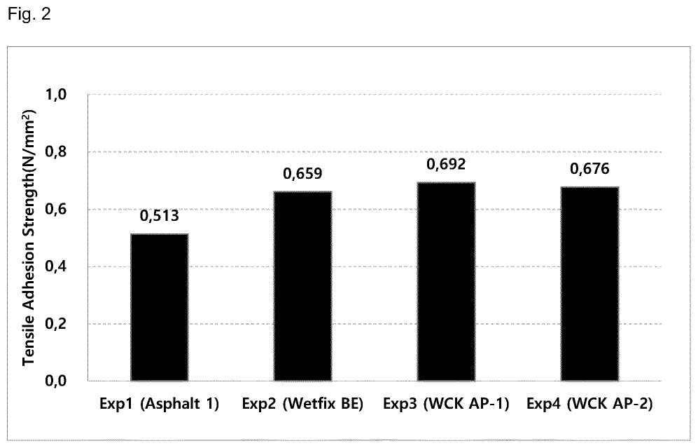

On the other hand, the asphalt binder (Exp 3) to which the VAE-based polymer adhesion promoter was applied exhibited a maximum adhesion strength of 0.692 N/mm² until breakage. This is a value higher than that of the asphalt binder (Exp 2) to which the surfactant-type adhesive was applied, exhibiting effects of adhesion improvement of about 35% with respect to the general asphalt (Exp 1). The asphalt binder (Exp 4) of Embodiment 4 also exhibited 0.676 N/mm², which is slightly higher than that of the surfactant-type adhesive (Exp 2), and it was appreciated that the effect of adhesion improvement of about 32% with respect to the general asphalt (Exp 1) (see FIG. 2 below).

### Experimental Embodiment 3. Viscosity Evaluation

In order to evaluate the rheology of the asphalt binder to which the VAE-based polymer adhesion promoter composition according to an embodiment is applied, the viscosity was measured as follows.

Specifically, the viscosity of the asphalt binders of Table 2 was measured with a Brookfield rotational viscometer under conditions of 20 rpm at 135° C. In such a case, a test was conducted according to the ASTM D4402 “Standard Test Method for Viscosity Determination of Asphalt at Elevated Temperatures Using a Rotational Viscometer”.

As a result of the experiment, the general asphalt (Exp 1) containing no adhesion promoter exhibited a viscosity of 100 cps. On the other hand, in the case of the asphalt binder (Exp 2) to which the conventional representative surfactant-type adhesive was applied, it was about 40 cps such that the viscosity tended to be slightly lowered as compared to the general asphalt.

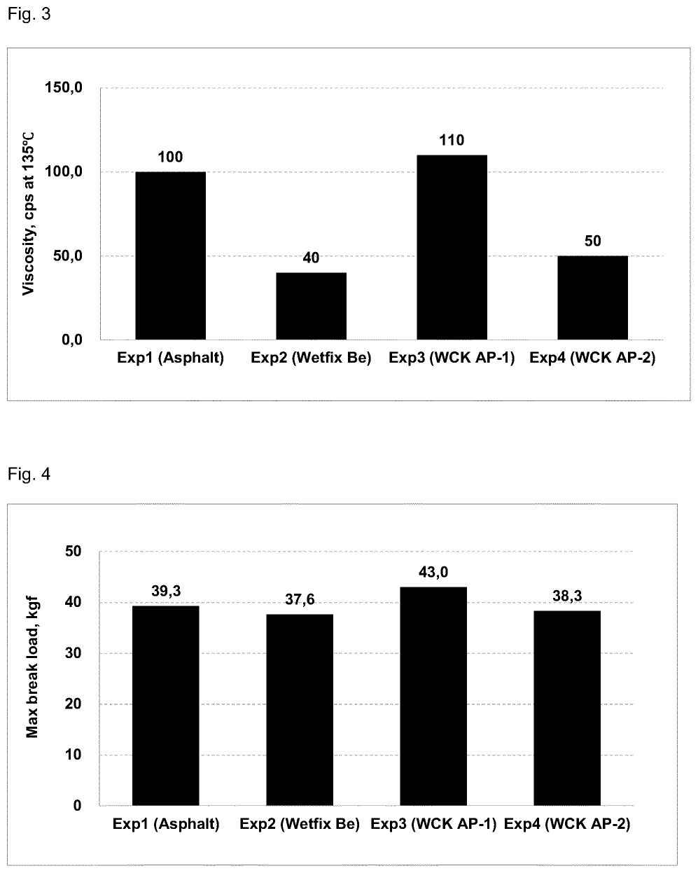

On the other hand, in the case of the asphalt binder (Exp 4) to which the VAE-based polymer adhesion promoter (WCK AP-2) was applied exhibited 50 cps, which is a level substantially equal to that of the asphalt binder (Exp 2) to which the conventional surfactant-type adhesive was applied, thus exhibiting effects of viscosity reduction of about 50% as compared to the general asphalt Exp 1 (see FIG. 3 below). In addition, the asphalt binder (Exp 3) to which the VAE-based polymer adhesion promoter (WCK AP-1) was applied exhibited a viscosity of 110 cps. It was appreciated that this is slightly higher than the viscosity of the asphalt binder (Exp 2) to which the conventional surfactant-type adhesive is applied and the viscosity of the asphalt binder (Exp 4) to which the VAE-based polymer adhesive (WCK AP-2) was applied, but has a level substantially equal to that of the general asphalt.

In general, in the case of the asphalt modified with an SBS polymer, the viscosity tends to increase significantly due to the application of the polymer, but it was appreciated that the viscosity increase was not relatively large when the VAE-based polymer was applied (see FIG. 3 below).

### Experimental Embodiment 4. Evaluation of Physical Properties of Asphalt Mixture

In order to identify cohesion properties of the asphalt mixture to which the VAE-based polymer adhesion promoter composition according to an embodiment is applied, the adhesion was evaluated as follows.

Specifically, after preparing an asphalt mixture as shown in Table 4 below, indirect tensile strength (IDT) was measured according to an experiment method according to the ASTM D6931, “Standard Test Method for Indirect Tensile (IDT) Strength of Asphalt mixtures” American Society for Testing and Materials”. The results are shown in each of Table 4 and FIG. 4.

TABLE 4

| | | | Mixing ratio of asphalt mixture | | | |
|---|---|---|---|---|---|---|
| | | | for evaluating mixture (wt %) | | | |
| | | | 1 | 2 | 3 | 4 |
| Asphalt | Aggregate | | 49.5 | 49.5 | 49.5 | 49.5 |
| mixture | (13 mm aggregate) | | | | | |
| | Stone dust | | 43.7 | 43.7 | 43.7 | 43.7 |
| | (Quarry dust) | | | | | |
| | Slaked lime | | 2.0 | 2.0 | 2.0 | 2.0 |
| | (hydrated lime, | | | | | |
| | calcium hydroxide) | | | | | |
| | Asphalt | Exp 1 | 4.8 | | | |
| | binder | Exp 2 | | 4.8 | | |
| | | Exp 3 | | | 4.8 | |
| | | Exp 4 | | | | 4.8 |

| | | | | | |
|---|---|---|---|---|---|
| Physical | Maximum load | 39.3 | 37.6 | 43.0 | 38.3 |
| properties | at Break (kgf) | | | | |

As a result of the experiment, in the case of a mixture of the general asphalt (Exp 1) containing no adhesion promoter, it exhibited 39.3 kgf as a maximum breaking strength. On the other hand, in the case of the asphalt mixture to which the conventional representative surfactant-type adhesive (Exp 2) was applied, it exhibited 37.6 kgf, and rather, the maximum breaking strength was decreased by about 4.3% as compared to the general asphalt. Based on this, it is appreciated that the conventional surfactant-type adhesive may partially improve adhesion properties of the asphalt mixture through tackiness of the surface, but adhesion and cohesion between each component in the asphalt mixture may not be sufficiently achieved, essentially causing a decrease in the strength of the final asphalt mixture.

On the other hand, in the case of the asphalt mixture to which the VAE-based polymer adhesion promoter (Exp 3) was applied, the maximum breaking strength was 43.0 kgf, which was enhanced by about 9.4% as compared to the general asphalt (Exp 1), and in particular, improved by about 14.4% as compared to the asphalt mixture (Exp 2) to which the conventional surfactant-type adhesive was applied. In addition, in the case of the asphalt mixture to which the VAE-based polymer adhesion promoter (Exp 4) was applied, a maximum breaking strength was 38.3 kgf, so it was appreciated that the breaking strength was slightly improved as compared to the asphalt mixture (Exp 2) to which the conventional surfactant-type adhesive was applied.

Based on the above results, it was appreciated that the VAE-based polymer adhesion promoter according to an embodiment is effective in increasing both of the adhesion and the cohesion between each component constituting the asphalt mixture (see Table 4 and FIG. 4).

1-20. (canceled)

21. An asphalt binder comprising:
an asphalt; and
an adhesion promoter composition comprising:
a vinyl acetate-ethylene (VAE)-based redispersible polymer; and
a wetting agent,
wherein the wetting agent comprises at least one selected from the group consisting of: polyethylene glycol phenyl ether, polyethylene glycol higher alkyl, ether dialkyl sulfosuccinate, alkyl amine, alcohol amine, polyethyleneimine, and sorbitan aliphatic ethylene oxide adduct,
wherein the wetting agent is included in an amount ranging from 0.5 to 45 percent by weight (wt %) with respect to the total weight of the adhesion promoter composition.

22. The asphalt binder of claim 21, wherein the VAE-based redispersible polymer comprises:
a VAE copolymer having a vinyl acetate (VA) content of more than 50 wt % with respect to the total weight of the VAE-based redispersible polymer; and
a filler.

23. The asphalt binder of claim 22, wherein the VAE copolymer comprises a vinyl acetate in an amount more than 50 wt % and less than or substantially equal to 99 wt %; and
an ethylene in an amount more than or substantially equal to 1 wt % and less than 50 wt %.

24. The asphalt binder of claim 22, wherein the VAE copolymer has a glass transition temperature (Tg) ranging from −40° C. to 25° C.

25. The asphalt binder of claim 22, wherein the filler comprises an organic filler, an inorganic filler, or a mixture thereof.

26. The asphalt binder of claim 22, wherein the filler is included in an amount ranging from 0.1 to 30 wt % with respect to 100 wt % of the VAE-based redispersible polymer.

27. The adhesion promoter composition of claim 21, wherein the wetting agent is alkyl amine-based.

28. The asphalt binder of claim 21, wherein the adhesion promoter composition further comprises a crosslinking agent in an amount ranging from 0.1 to 15 wt % with respect to the total weight of the adhesion promoter composition.

29. The asphalt binder of claim 28, wherein the crosslinking agent comprises at least one selected from the group consisting of: an organic peroxide crosslinking agent, a silane crosslinking agent, an azo crosslinking agent, a polyisocyanate crosslinking agent, sulfur and sulfides.

30. The asphalt binder of claim 21, wherein the adhesion promoter composition further comprises a rheology modifier in an amount ranging from 0.1 to 30 wt % with respect to the total weight of the adhesion promoter composition.

31. The asphalt binder of claim 30, wherein the rheology modifier comprises at least one selected from the group consisting of: polyurethane, acrylic polymers, latex, styrene/butadiene, polyvinyl alcohols, cellulosic resins, sulfonates, gums, sacharides, proteins, waxes, organosilicones, modified castor oil, petroleum oil, tall oil, rosin acid, lubricant, process oil, vegetable oil, seed oil, bio-lubricating oil, recycle oil, phthalate, trimellitate, silicon surfactant and a non-meltable component.

32. The asphalt binder of claim 31, wherein the non-meltable component comprises at least one selected from the group consisting of: clay, lime, silica, fume silica, carbon black, cellulose, and fiber.

33. The asphalt binder of claim 21, wherein the adhesion promoter composition is in a powder or liquid form.

34. The asphalt binder of claim 21, wherein the adhesion promoter composition is included in an amount ranging from 0.1 to 20 wt % with respect to the total weight of the asphalt binder.

35. The asphalt binder of claim 21, wherein a maximum load at break of the asphalt binder is more than or substantially equal to 38.0 kgf in an indirect tensile strength (IDT) test according to the ASTM D6931 standard.

36. The asphalt binder of claim 21, satisfying at least one physical property of the following (i) to (iii):
(i) a maximum viscosity (on the basis of 135° C.) according to the ASTM D4402 standard is less than or substantially equal to 500 cps,
(ii) an adhesion strength at which breakage occurs according to the KS L ISO13007-2 standard is more than or substantially equal to 0.50 N/mm², and
(iii) a stripping rate according to the ASTM D3625 standard is less than or substantially equal to 5%.

37. An asphalt mixture comprising the asphalt binder of claim 21, an aggregate and a filler.

38. The asphalt mixture of claim 27, wherein the asphalt binder is included in an amount ranging from 0.5 to 20 wt % with respect to the total weight of the asphalt mixture.
